(19) United States
(12) Patent Application Publication
(10) Pub. No.: US 2016/0324142 A1
(43) Pub. Date: Nov. 10, 2016

(54) Decoy System and Method of Manufacturing and Use

(71) Applicant: Hawkeye Plastic Products Co., Nashua, IA (US)

(72) Inventor: Steven O. Stirling, Nashua, IA (US)

(21) Appl. No.: 15/146,949

(22) Filed: May 5, 2016

Related U.S. Application Data
(60) Provisional application No. 62/157,644, filed on May 6, 2015.

(51) Int. Cl. A01M 31/06; B05D 5/00; B05D 1/20; A01M 99/00

(52) U.S. Cl. CPC A01M 31/06; A01M 99/00; B05D 5/00; B05D 1/20

(57) ABSTRACT

A decoy system having a body and a head. The body includes an underside having a keel and at least one string attachment member. A string is connected to the string attachment member and a weight. The keel includes a first recess and a second recess. In a storage position, the string is wrapped around the first recess in the keel and the weight clips onto the second recess thereby holding the string and weight in place when in a storage position. The keel and weight are generally low-profile in nature and have a generally flat bottom thereby allowing the decoy to sit upright when used on dry land. The decoy quickly converts to a deployed position where the weight is detached from the keel for use in water. In one arrangement, the graphics on the exterior surface of the body and/or head a applied using a hydro-dipping process.

### CROSS REFERENCE TO RELATED APPLICATION

This application claims the benefit of U.S. Provisional Application No. 62/157,644 filed on May 6, 2016.

### FIELD OF THE INVENTION

This invention relates generally to decoys. More specifically, and without limitation, this invention relates to a decoy system and a method of manufacturing and use thereof.

### BACKGROUND OF INVENTION

Decoys are old and well known in the art. The earliest known decoys are carved out of wood and are hand colored or painted. While these original decoys certainly served their intended purpose, carving decoys out of wood and hand coloring or painting them is an extremely time consuming endeavor which requires a certain level of artistry. In addition, wooden decoys are heavy and susceptible to water absorption and deterioration making them an undesirable choice for use in the field, especially for use with waterfowl hunting where the decoys are often floated in water which speeds the deterioration process. Another deficiency with respect to wooden decoys is that the materials and labor involved make wooden decoys prohibitively expensive.

Along with the advent and mass adoption of plastics, plastic decoys were developed. These plastic decoys eliminated some, but not all, of the deficiencies of wooden decoys. Namely, manufacturing decoys out of plastic allowed for mass production of decoys thereby eliminating much of the labor costs associated with hand carving decoys out of wood. In addition, because most plastics are generally water resistant, using plastics to form decoys eliminated the potential for the decoys to rot when exposed to water.

However, plastic decoys presented many new problems. Namely, while the body of a decoy can be manufactured out of plastic, plastic decoys still required painting before use. Many plastic decoys were painted by hand, like wooden decoys, which is again an extremely labor intensive and time consuming process. Alternatively, some automated painting processes were developed, such as spray painting. While spray painting may increase the speed of painting, these processes provided poor quality and low levels of detail, not to mention required sophisticated and expensive equipment and facilities.

Plastic decoys also suffered from design problems. That is, most plastic decoys are hollow, and therefore when used in water, their design caused them to be unbalanced and have a tendency to roll over or onto their side during use.

To correct this problem, keels were added to the bottom of plastic decoys to provide a counter balance on the water. While adding a keel to the bottom of a conventional plastic decoy helped to maintain the decoy in an upright manner when floating, adding a keel created a problem when using the decoy in a field on the ground. That is, having a keel made the decoy unusable in the field because while the keel helped the decoy float upright the keel had the opposite effect when used in the field. That is, when set in a field for dry-land hunting, the keel which protrudes from the underside of the decoy caused the decoy to tilt to its side or roll over. In addition, the presence of the keel raised the body of the decoy high above the ground giving the decoys an unnatural appearance therefore causing the decoys to be unusable for field hunting.

Another deficiency with respect to the keel design of conventional decoys is that many keel designs include an elongated protrusion extending downward from the center of the decoy body, much like the keel of a boat. This conventional keel design, which extends a distance from the front end to the rear end of the decoy causes an unnatural motion of the decoy when floating in windy conditions. That is, the elongated keel design of these decoys prevents the decoy from quickly and easily rotating in the water when the wind slightly changes direction.

In addition to these problems, conventional decoys provided no solution to what to do with the strings and weights often used with the decoys. That is, when used in water, a conventional weight is connected to the decoy by a string. These weighs are then thrown into the water and anchor the decoy to the bottom. These strings are often wrapped around the body or head of the decoys for transport to and from the field with the weight hanging freely by the loose end of the string. These strings and hanging weights have a tendency to get tangled with the strings and weights of other decoys during transport, such as when placed in a bag or on the bottom of a duck boat with other decoys. This can cause a dangerous and frustrating condition, especially considering that decoys are often deployed and collected in the darkness of night. Further, when the strings are wrapped around the body or head of a decoy, these strings must be unwrapped from the decoy's body or head before use, especially when used in dry land hunting, which is a time consuming and inefficient process.

Therefore, for the reasons stated above, and for other reasons stated below which will become apparent to those skilled in the art upon reading and understanding the specification, there is a need in the art for an improved decoy system and a method of manufacturing and use thereof.

Thus, an object of the invention is to provide an improved decoy system and a method of manufacturing and use thereof that improves upon the present state of the art.

Another object of the invention is to provide an improved decoy system that is high quality.

Yet another object of the invention is to provide an improved decoy system that is easy to use.

Another object of the invention is to provide an improved decoy system that is durable.

Yet another object of the invention is to provide an improved decoy system is inexpensive.

Another object of the invention is to provide an improved decoy system can be used in water or on land.

Yet another object of the invention is to provide an improved decoy system that is convenient to use.

Another object of the invention is to provide an improved decoy system that eliminates or reduces tangles.

Yet another object of the invention is to provide an improved decoy system that sits upright in water or on land.

Another object of the invention is to provide an improved decoy system that provides a convenient place for storing the string.

Yet another object of the invention is to provide an improved decoy system that holds the string in place.

Another object of the invention is to provide an improved decoy system that has an intuitive design.

Yet another object of the invention is to provide an improved decoy system that reduces the cost of painting.

Another object of the invention is to provide an improved decoy system that speeds the painting process.

Yet another object of the invention is to provide an improved decoy system that eliminates the need for conventional painting.

Another object of the invention is to provide an improved decoy system that has a high quality intricate ornamental appearance.

Yet another object of the invention is to provide an improved decoy system that can be deployed more-quickly in the field.

Another object of the invention is to provide an improved decoy system that can be retrieved and stored more-quickly in the field.

Yet another object of the invention is to provide an improved decoy system that is less frustrating to use.

Another object of the invention is to provide an improved decoy system that is safer to use.

Yet another object of the invention is to provide an improved decoy system that provides a natural motion when used in the water.

Another object of the invention is to provide an improved decoy system that has an articulating head.

These and other objects, features, or advantages of the invention will become apparent from the specification and claims.

### SUMMARY OF THE INVENTION

A decoy system having a body, a head, an underside having a keel and at least one string attachment member. A string is connected to the string attachment member and a weight. The keel includes a first recess and a second recess. In a storage position, the string is wrapped around a recess in the keel and the weight clips onto a recess thereby holding the string and weight in place when in a storage position. The keel and weight are generally low-profile in nature and have a generally flat bottom thereby allowing the decoy to sit upright when used on dry land. The decoy quickly converts to a deployed position where the weight is detached from the keel for use in water. In one arrangement, the graphics on the exterior surface of the body and/or head are applied using a hydro-dipping process.

### BRIEF DESCRIPTION OF THE DRAWINGS

FIG. 1 is a bottom perspective view of a decoy, the view showing the decoy body and head, a keel and a front and rear string attachment members, the string connected to the front string attachment member and wrapped around the keel before connecting to the weight, the view showing the weigh placed around the keel and the string thereby holding the weight and the keel in place;

FIG. 2 is a front elevation view of the decoy of FIG. 1;

FIG. 3 is a rear elevation view of the decoy of FIG. 1;

FIG. 4 is a left side elevation view of the decoy of FIG. 1;

FIG. 5 is a right side elevation view of the decoy of FIG. 1;

FIG. 6 is a top elevation view of the decoy of FIG. 1;

FIG. 7 is a bottom elevation view of the decoy of FIG. 1;

FIG. 8 is a bottom perspective view of the decoy of FIG. 1, the view showing the string unwrapped from the keel and the weight unattached from the keel;

FIG. 9 is a plan view of a process flow diagram of one method of manufacturing the decoy of FIG. 1;

FIG. 10 is a plan view of a film with a hen (female duck) feather pattern printed thereon that is used during a hydro-dipping process;

FIG. 11 is a plan view of a film with a drake (male duck) feather pattern printed thereon that is used during a hydro-dipping process.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention(s). The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the invention.

In addition, while the system presented herein is shown and described primarily with a duck decoy, the system is not limited to use with duck decoys. Instead, reference to a duck decoy is merely one of countless applications. It is hereby contemplated that the system can be used with any type of decoy. Furthermore, it is hereby contemplated that the system can be used with any applicable mechanical device.

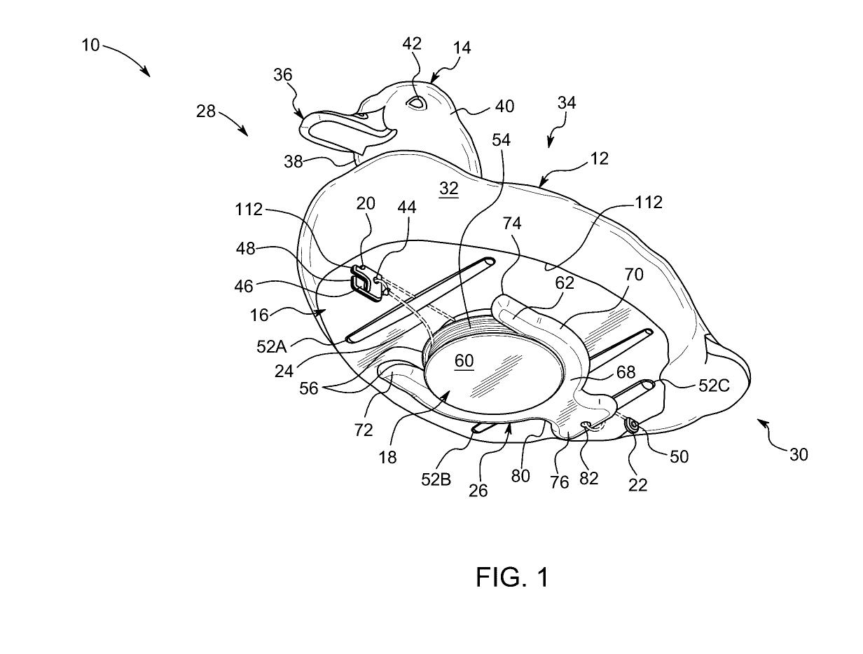

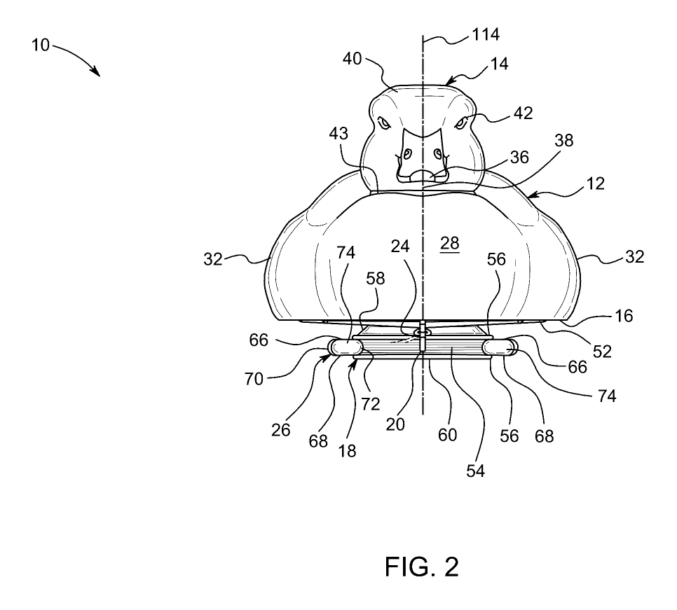

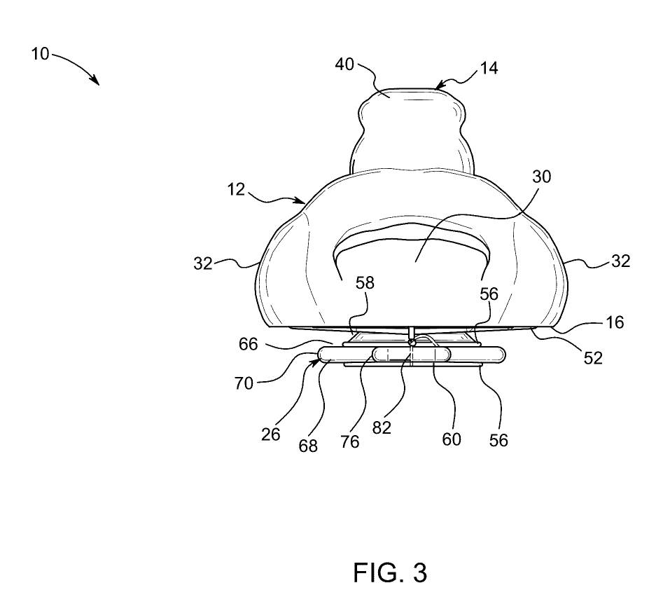

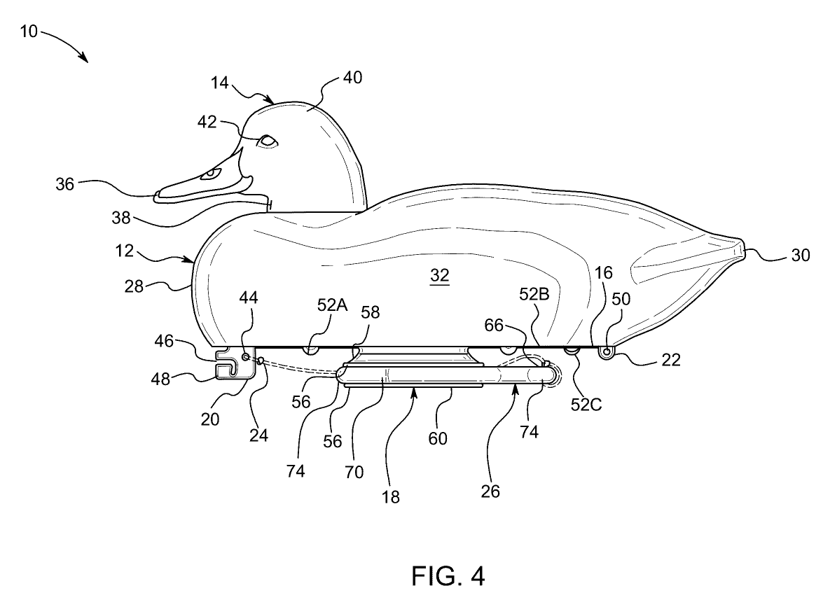

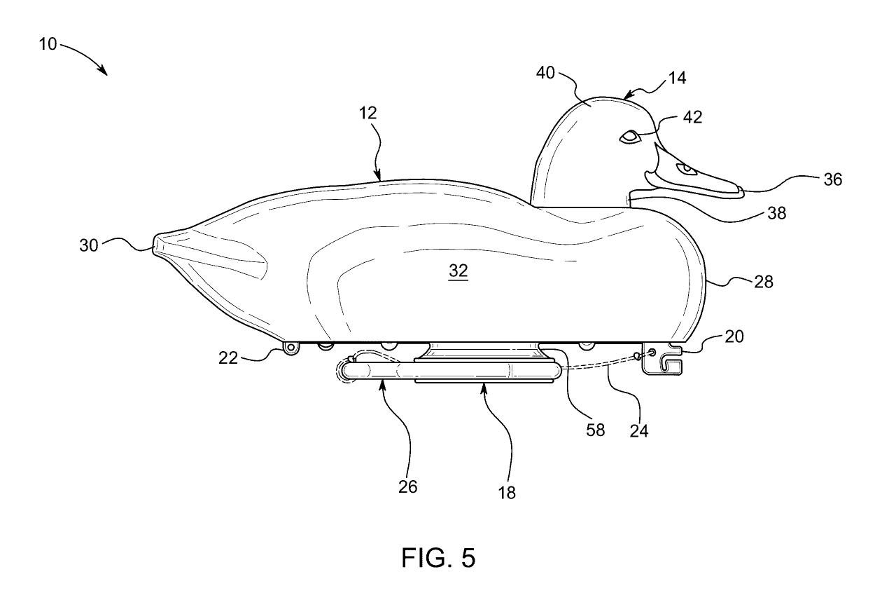

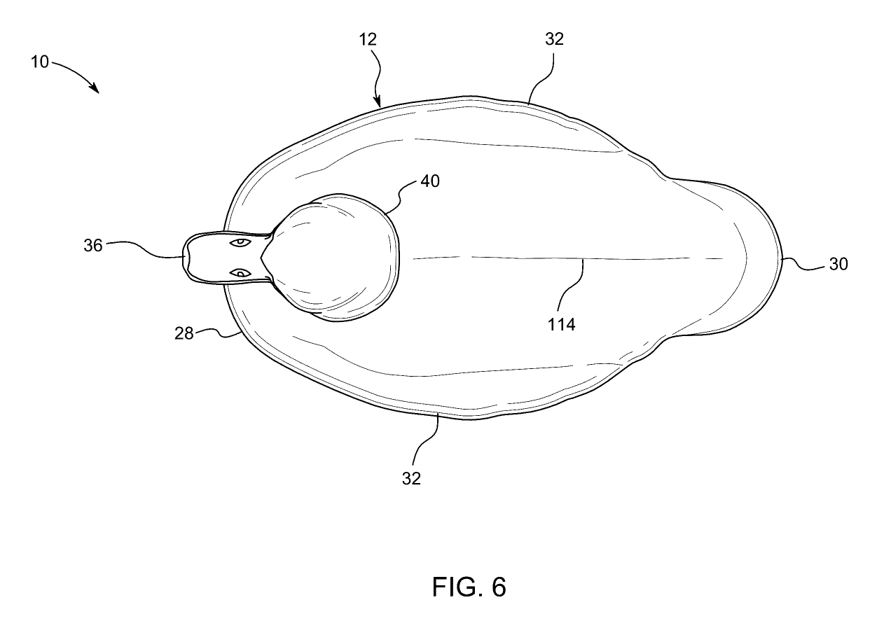

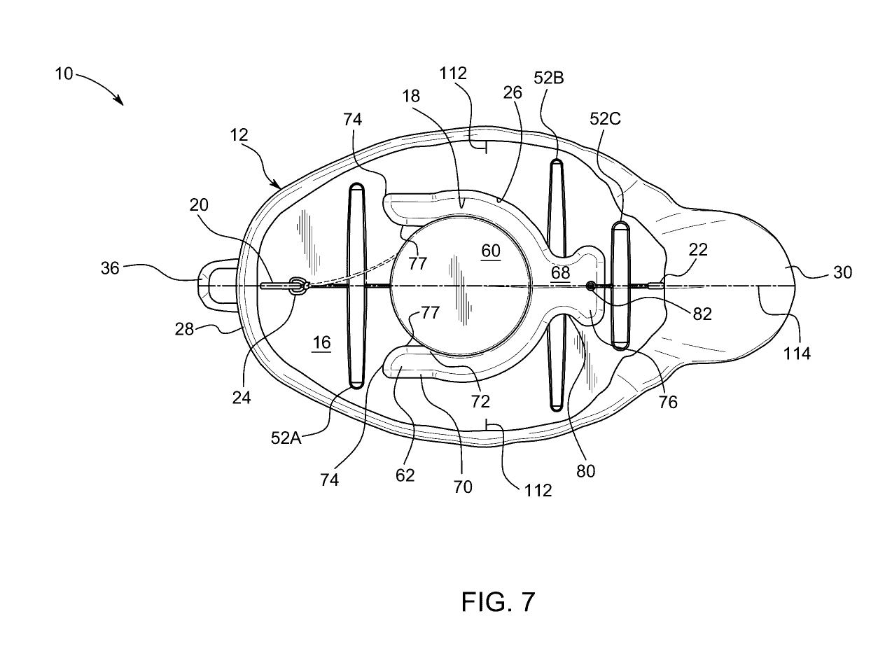

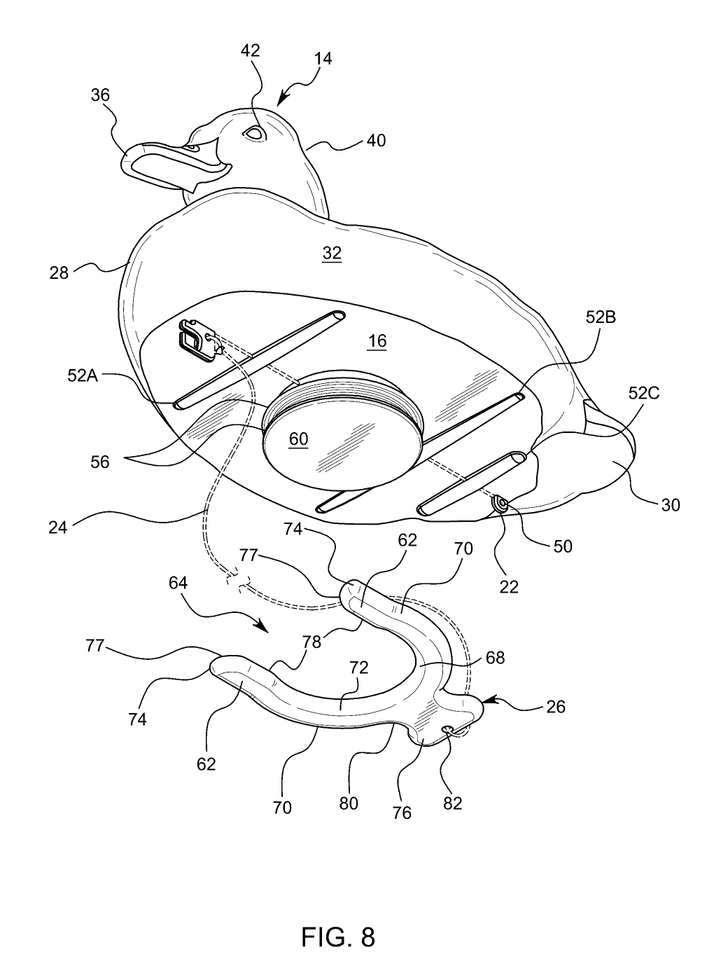

With reference to the Figures, a decoy system 10 is presented. The decoy system 10 is formed of any suitable size, shape and design. In one arrangement, as is shown, the decoy system 10 includes a body 12 having a head 14 connected to the body 12. The body 12 also includes an underside 16 having a keel 18 extending outwardly or downward therefrom, as well as a front string attachment member 20 and a rear string attachment member 22. A string 24 is connected to one of the front string attachment member 20 or rear string attachment member 22 on one end and to a weight 26 on an opposite end of the string 24. The decoy system 10 quickly and easily converts between a storage position, as shown in FIGS. 1-7, wherein the string 24 is wrapped around the keel 18 and the weight 26 is placed over the keel 18, and a deployed position, as shown in FIG. 8, wherein the string 24 is unwrapped from the keel 18 and the weight 26 is detached from the keel 18.

Body 12 is formed of any suitable size, shape and design. In the arrangement shown, body 12 is that of a duck or other waterfowl, however any other animal or object is hereby contemplated for use, including any object that is often used in water such as buoys, floating markers, floating toys, floating signs, floating coolers, floating tools, or the like.

Body 12 includes a forward side 28 that is generally rounded and in the arrangement shown, depicts the breast area of a duck. Body 12 includes a rearward side 30 that in the arrangement shown, depicts the tail section of a duck. Body 12 includes opposing sides 32 (that is a left side and an opposing right side) that in the arrangement shown depicts the wing sections of a duck. Body 12 includes an upper side 34 that in the arrangement shown depicts the back or upper surface of a duck. As is shown, in one arrangement, these surfaces are generally textured or contoured to mimic the outward appearance of a duck.

Head 14 is connected to body 12. Head is formed of any suitable size, shape and design. In the arrangement shown, head 14 is connected to the upper forward side of body 12 and extends upwardly and outwardly therefrom. Head 14 includes a forward side 36 that in the arrangement shown, depicts the beak section of a duck. Head 14 includes a middle section 38 that in the arrangement shown, depicts the neck or throat section of a duck. Head 14 includes an upper section 40 that in the arrangement shown, depicts the head section of a duck. Head 14 also includes a pair of eyes 42.

Head 14 is, in one arrangement formed as a single, monolithic and unitary piece with body 12. In this arrangement, when body 12 is formed, such as through injection molding, rotational molding, (also known as rotomolding), casting, 3-D printing, blow molding, or the like manufacturing processes, head 14 is simultaneously formed. In this arrangement, head 14 is static and remains in the position it is formed in.

In an alternative arrangement, head 14 is formed separately from body 12. In this arrangement, separate head 14 is attached to body 12 in an additional manufacturing step. In one arrangement, separate head 14 is permanently affixed to body 12 in a stationary position such as through welding, gluing, adhering or permanently affixing by any other manner or method. In this arrangement, head 14 is non-movable with respect to body 12 once attached.

In an alternative arrangement, separate head 14 is connected to body 12 in a movable, or rotational manner. That is, head 14 is mechanically connected to body 12 so as to allow its movement relative to body 12. This can be accomplished in one arrangement, when head 14 and body 12 connect together using a snap-fit or friction-fit arrangement where a protrusion or groove connected to one of the head 14 or body 12 fits in a locking manner within a recess or protrusion in the other of the head 14 or body 12 that allows head 14 to move or rotate with respect to body 12. There are situations wherein a fixed or static connection between head 14 and body 12 are desirable, and situations wherein the flexibility of being able to rotate or move head 14 with respect to body 12 is preferred. As such, each has their advantages and both are contemplated herein for use. In addition the ability to replace heads 14 is desirable in the event a head 14 is damaged.

More specifically, in one arrangement, as is shown, body 12 includes a circular opening 43 that receives a collar 43A (not shown) that extends outwardly from the bottom side of the head 14 and includes a groove 43B (not shown) therein. During assembly, collar 43A is forced into the opening 43 until the groove 43B is received within opening 43. In this position, the head 14 is tightly held in place on the body 12, while allowing head 14 to rotate upon body 12 when a user applies a rotational force greater than the frictional force holding the head 14 to the body 12. In addition, head 14, can be removed from body 12 by overcoming the friction which holds the head 14 onto the body 12. Allowing the head 14 to rotate with respect to the body 12 allows the user to provide a plurality of decoys 10 that have slightly different appearance. This improves functionality and the life-like nature of the decoys 10. In addition, by providing a removable head 14, this allows for a plurality of heads to be used with the same body 12 such as a pruning head, a head that looks straight forward, etc. In addition, by providing a removable head 14 this allows the manufacturing process for the head 14 and the body 12 to be different. That is, as one example, the head 14 is spray painted or air brushed while the body 14 is hydrodipped, or any other combination or configuration.

Underside 16 of body 12 is formed of any suitable size, shape and design. In one arrangement, as is shown, underside 16 is generally flat and establishes a plane.

A front string attachment member 20 and a rear string attachment member 22 extend outwardly and downwardly from underside 16. Front string attachment member 20 and a rear string attachment member 22 are formed of any suitable size, shape and design and are generally formed so as to allow easy attachment of string 24 thereto. In the arrangement shown, front string attachment member 20 is generally centrally positioned toward the forward side 28 of body 12. Similarly, in the arrangement shown, rear string attachment member 22 is generally centrally positioned toward the rearward side 30 of body 12. In this way, the front string attachment member 20 and rear string attachment member 22 are aligned with one another along a centrally extending vertical line or plane through decoy 10, this line or plane extends in general perpendicular alignment with the generally flat plane formed by underside 16. Alignment of the front string attachment member 20 and rear string attachment member 22 along this centrally extending plane helps to keep the decoy 10 in a generally natural, proper and predictable alignment when in use.

While any configuration is hereby contemplated for use, in the arrangement shown, front string attachment member 20 has a tab or body that extends downward from underside 16. Front string attachment member 20 includes an opening 44 positioned adjacent its rearward side through which string 24 is attached. As is shown, string 24 is connected at its first end to this opening 44, from there string 24 is wrapped around keel 18 as is further described herein, before connecting to weight 26.

Front string attachment member 20 also includes a notch 46. Notch 46 is sized and shaped to receive and hold a portion of string 24 through frictional engagement. In the arrangement shown, forward facing notch 46 includes a flexible arm 48 that extends forwardly from notch 46 and closes notch 46. Flexible arm 48 selectively closes notch 46 and allows string 24 to be inserted into as well as removed from notch 46 with frictional holding force. This allows a user to adjust the length of string 24 without the need to tie or knot string 24, which improves ease of use and speed of use and obviates the potential for knots that are difficult to untie. The size and shape of notch 46 tends to hold the portion of string 24 when inserted therein. Alternatively a loop is placed in the string 24 when inserted in notch 46 and cinched tight. That is, notch 46 allows a user to wrap string 24 between front string attachment member 22 and keel 18 to adjust the free length of string 24. This is desirable in certain situations, such as when decoy 10 is used in shallow water and high wind conditions and it is desirable to keep decoy 10 on a “short leash” so as to prevent decoy 10 from getting tangled with other decoys 10 in a set.

In one arrangement, rear string attachment member 20 is similar if not identical to forward string attachment member 20, only arranged facing the opposite direction and positioned rearward of keel 18, instead of forward of keel 18. In another arrangement, as is shown, rear string attachment member 22 is a downwardly extending tab including an opening 50 therein. Opening 50, in one arrangement, is used to attach a second string 24 thereto that connects to a second decoy 10. In this way, rear string attachment member 22 is used to connect two or more decoys together in a string and thereby allows a user to quickly set two or more decoys at the same time. In addition, the inclusion of a front string attachment member 20 and a rear string attachment member 22 allows for the flexibility of attaching the decoy 10 by either the front side 28 or the rear side 30.

Underside 16 also includes one or a plurality of protrusions 52. Protrusions 52 are formed of any suitable size, shape and design. In one arrangement, protrusions 52 are generally elongated members that protrude downwardly from the plane of underside 16. In the arrangement shown, the length of protrusions 52 extend across the bottom surface of underside 16 in approximate perpendicular alignment to the plane or line extending between front string attachment member 20 and rear string attachment member 22. Said another way, the length of protrusions 52 extend in approximate perpendicular alignment to the front 28 to back 30 length of decoy 10, or said yet another way protrusions 52 extend side 32 to side 32 in approximate perpendicular alignment between the head section and tail section of decoy 10.

In the arrangement shown, a first protrusion 52A is positioned forward of keel 18 and extends across the majority of underside 16 but terminates short of the intersection of underside 16 and sides 32. A second protrusion 52B is positioned just rearward of keel 18 and extends across a majority of underside 16 but terminates short of the intersection of underside 16 and sides 32. A third protrusion 52C is positioned rearward of second protrusion 52B and before underside 16 terminates and extends across a majority of underside 16 but terminates short of the intersection of underside 16 and sides 32. As the underside 16 varies in width as the width of the body 12 of decoy 10 varies, the second protrusion 52B is the widest as it is positioned nearest the widest portion of body 12, the next widest is the first protrusion 52A followed by the third protrusion 52C which is the narrowest protrusion 52, however any other arrangement is hereby contemplated for use. Any other number and position of protrusions are hereby contemplated for use such as none, one, two, four, five or more. Protrusions 52 while laterally elongated between sides 32 have a generally rounded lower surface that extends downward from underside 16 a short distance. The protrusions are generally deeper or thicker toward the middle of decoy 10 and taper to shallower as they extend outward toward opposing sides 32. Protrusions 52 in one arrangement serve a structural function and provide strength and rigidity to decoy 10 by providing additional structure to underside 16 and breaking up the flat plane of underside 16. In this arrangement, protrusions 52 provide additional strength to underside 16 much like corrugation provides strength to a sheet of galvanized steel. Protrusions 52 in another arrangement provide a balance or weighting function as well. That is, protrusions 52 utilize additional material and therefore their presence in underside 16 provides additional weight and thereby helps to keep decoy 10 floating in an upright fashion. Protrusions 52 can serve both these functions as well as other functions.

Keel 18 is also connected to underside 16 and extends downward therefrom a distance. Keel 18 is formed of any suitable size, shape and design. Keel 18 is generally centrally positioned with respect to the center of mass of decoy 10. This central positioning helps to keep decoy 10 floating in an upright position when used in water, and helps to keep decoy 10 flat and level when used on dry land.

In one arrangement, when viewed from below, keel 18 is generally circular in shape and extends downward in generally perpendicular alignment to the plane of underside 16. When viewed from the side, the generally cylindrical downward extension of keel 18 includes a first recess or groove 54 therein. That is, the generally cylindrical keel 18 includes a first recess or groove 54 that is positioned between opposing flanges 56 positioned above and below the first recess or groove 54. This arrangement provides a convenient narrow area within first recess or groove 54 to wrap string 24 there around. Sting 24 is then held within this recess or groove 54 by the flanges 56 positioned above and below the first recess or groove 54 thereby preventing their unintentional escape. While keel 18 is shown as circular in nature, keel 18 may be square, rectangular, oval, octagonal, or any other shape and still function in a similar manner and achieve the set-out goals described herein.

In addition, in one arrangement, a neck section 58, or second recess or groove, extends downward from underside and connects to the keel 18. That is, in one arrangement, neck section 58, or second recess or groove is positioned between the bottom of the underside 16 and the upper surface of the upper flange 56. In the arrangement shown, neck section 58 is narrower at its top end where it connects to underside 16 and angles outward as it extends downward before connecting to the upper surface of upper flange 56. In this way, neck section is partially cone shaped or angled.

In one arrangement, instead of wrapping string 24 around the first recess or groove 54 of keel 18, string 24 is wrapped around neck section 58. Wrapping string 24 around neck section 58 prevents the string 24 from interfering with the connection of weight 26 with the first recess or groove 54 of keel 18. That is, if too much string 24 is wrapped around keel 18, this may prevent weight 26 from being easily snapped or frictionally fit over keel 18. In addition, because neck section 58 narrows as it extends upward from the keel 18 to the underside 16, this causes the string 24 to stack or tighten on or bind to itself as additional wraps or layers are added thereby helping to prevent unintentional unwinding (as well as tangling) of the string 24 once placed in a storage position. In an alternative arrangement, a portion of string 24 is wrapped around keel 18 between flanges 56 and a portion of sting 24 is wrapped around neck section 58.

Keel 18 provides many advantages. Namely, keel 18 provides a convenient and easy place to wrap string 24 there around. In addition, Keel 18 serves as a holding member that allows weight 26 to be connected thereto. In addition, keel 18 helps to keep decoy upright while being used in water or on land.

To facilitate the decoy 10 sitting upright when used on dry land, the bottom surface 60 of keel 18 is generally flat and forms a plane that extends in approximate parallel spaced alignment to the plane of underside 16, positioned a distance below underside 16. To further facilitate the decoy 10 to sit upright when used on dry land, keel 18 is generally short in a vertical manner. That is, the keel 18 is vertically narrow or short in height. This short vertical length makes it easier for the decoy 10 to sit upright when placed in a field and reduces the potential for the decoy 10 to roll-over onto its side when used on dry land by lowering the decoy's center of gravity.

While first recess or groove 54 can be formed of any size and shape, in one arrangement, as is shown, recess or groove 54 is generally rounded or semi-circular in shape when viewed from the side such as a C-Shape, a U-shape or the like. However, any other shape is hereby contemplated for use such as a square or rectangular groove, an angled groove or any other form of a groove.

Decoy system 10 includes a weight 26. Weight 26 is formed of any suitable size, shape and design. In one arrangement, as is shown, weight 26 includes a pair of fingers 62 that form an opening 64 there between. Fingers 62 and opening 64 are sized and shaped to frictionally receive keel 18 therein, or more specifically to frictionally fit around the first recess or groove 54 of keel 18. In this way, when keel 18, and recess or groove 54 therein is generally round or circular in shape, fingers 62 and opening 64 are similarly shaped to form a round or circular opening therein.

Weight 26 includes an upper surface 66 and a lower surface 68 which are generally flat or planar in shape and extend in approximate parallel spaced relation to one another. These flat upper surface 66 and lower surface 68 help to maintain the vertical width of weight as generally narrow. Weight 26 includes an exterior surface 70 which is opposed to an interior surface 72. Exterior surface 70 and interior surface 72 are generally rounded in shape when viewed from the side. Interior surface 72, which resides within opening 62 is generally sized and shaped to frictionally receive within close and tight frictional tolerances the first recess or groove 54 of keel 18. In addition, the upper flange 56 and lower flange 56 provide alignment to weight 26 when inserted over the first recess or groove 54.

To ensure that weight 26 remains in position around keel 18 when placed thereon, fingers 62 are generally elongated and are longer than the keel 18 is laterally wide. Fingers 62 begin at a rounded tip 74 and extend rearward therefrom before terminating in a back section 76. The interior surface 72 of fingers 62 angles slightly inward at an inwardly angled section 77 beginning just rearward of tip 74. These inwardly angled sections 77 provide a wider mouth to opening 62 that helps guide the weight 26 around keel 18 when being placed thereon. This inward angle continues to a tangent point 78 where the interior surface 72 again begins to widen slightly in a shape mimicking the shape of keel 18. The distance between opposing tangent points 78 is slightly narrower than the widest portion or diameter of keel 18. Therefore, a user most exert force to overcome the frictional engagement between opposing tangent points 78 on keel 18, or more specifically recess or groove 54. Once the tangent points 78 of weight 26 are over or slid past the widest section of keel 18, the weight 26 is frictionally locked onto keel 18 and cannot be removed without overcoming the frictional force existing between weight 26 (tangent points 78) and keel 18 (first recess or groove 54).

In the arrangement shown, rearward of tangent points 78, when viewed from above or below, the interior surface 72 is contoured to be generally circular in shape to conform to the shape of keel 18. In this way, once the exterior surface of keel 18 passes tangent points 78, the round exterior surface of first recess or groove 54 is received in mating fashion within the opening 64.

The interior surface 72 of weight 26 is conformed to engage and receive the first recess or groove 54 of keel 18. In one arrangement, when viewed from the front of weight 26, the interior surface 72 of weight is generally smooth or rounded and conforms to the size and shape of first recess or groove 54 of keel 18. In one arrangement, where first recess or groove 54 is generally semicircular in shape, the interior surface 72 of weight 26 is similarly but oppositely shaped so as to provide a mating frictional engagement there between. In this arrangement, when weight 26 is placed over keel 18, the interior surface 72 engages the inwardly facing surfaces of opposing flanges 56 thereby providing a frictional force holding engagement. In one arrangement, to facilitate this arrangement, weight 26 is approximately the same thickness as or is slightly thicker than the distance between flanges 56 so as to cause frictional engagement there between.

In one arrangement, a secondary groove is provided within or an additional depth is provided within recess or groove 54 to provide room for string 24 within recess or groove 54 without interfering with engagement of weight 26 being placed over keel 18. Alternatively, in an arrangement wherein string 24 is not intended to be wrapped around the first recess or groove 54 of keel 18, the interior surface 72 of weight 26, and or the tangent point 78 of weight 18 is sized just slightly smaller than the first recess or groove 54 such that it is these surfaces that engage one another and provide the frictional locking, yet removable, engagement between the two components.

Back section 76 of weight 26 includes a waist 80 that is narrower than other sections of back section 76. This narrower waist 80 allows for easy user grip, as well as enabling wrapping of string 24 there around if so desired to shorten the length of string 24. Back section 76 includes an opening 82 therein that allows string 24 to connect to weight.

Weight 26 is formed of any suitable design and material. In one arrangement, weight 26 is formed of a solid metallic piece such as steel, iron, lead or any other metallic material or alloy. In an alternative arrangement, weight 26 is formed of a solid piece of plastic, rubber or composite material or the like. In yet another alternative arrangement, weight 26 is formed of a core of one material, such as a metallic material, that is then covered in a layer of a second material, such as a plastic, rubber or composite material or the like. Providing a coating over a core material in this manner provides the density of the core material with the surface properties of the coating material. In one arrangement, where the core is metallic and the coating is plastic or composite, this arrangement provides the benefits of a dense and heavy metallic core with the rust prevention and forgiving nature of the surface plastic or composite.

In an alternative arrangement, weight 26 is formed of a mixture of a metallic material and a plastic or composite material. That is, in one arrangement, weight 26 is formed of a mixture of steel, or any other metallic material such as lead, iron, copper, or the like, and plastic or composite. In one arrangement, to form weight 25 in this manner, particlized, pelletized, powedered or granulated plastic is mixed with particlized, pelletized, powdered or granulated steel or other metallic material in the hopper of a molding machine, such as an injection molding machine, roto molding machine, blow molding machine or the like kind of machine, the plastic and metal constituents are then heated, mixed and pressurized and formed into a homogeneous or mostly homogeneous mixture. The metallic material and the plastic or composite material are mixed in a ratio so as to provide the optimal weight and density for weight 26 which is heavy enough to anchor decoy 10 but not excessively heavy so as to be inconvenient and create excess work when transporting decoy 10. In one arrangement, the composite (or plastic) and metallic (or steel) constituents create a homogeneous mixture or a generally homogeneous mixture such that the resulting weight 26 is generally consistent throughout the body of weight 26. In this arrangement, the weight 26 has a solid body. This arrangement eliminates the common practice of using lead for weight 26, which can have negative environmental and health affect.

In Operation:

The decoy system 10 presented herein can be used both in water and on dry land. When used in water, the weight 26 is removed from the first groove or recess 54 of keel 18. This is done by applying pressure on weight 26 such that weight 26 slides with respect to keel 18 until keel 18 is removed from the opening 64 in weight. Weight 26 becomes detached from keel 18 when the tangent points 78 of interior surface 72 pass the widest portion of keel 18. Once the weight 26 is detached the weight 26 and decoy 10 can then be thrown into the water at the desired place. When the weight 26 hits the water it begins to sink whereas when the decoy 10 hits the water it floats. Due to the natural balance of the decoy 10, and its low center of gravity due to its features and designs, the decoy 10 floats in an upright position. As the weight 26 sinks, the string 24 automatically unwinds itself from around the round keel 18 until it is free or fully deployed. This is the deployed position where the weight 26 is detached from the keel 18.

If desired, the string 24 can be shortened by wrapping a portion of the string 24 between a string attachment member 20/22 and the keel 18 or around the waist 80 on the weight 26. In one arrangement, a loop is placed in the string 24 thereby holding the desired length over the waist 80 or around a string attachment member 20/22.

The decoy 10 is quickly and easily returned to a storage position by retrieving the decoy 10 and wrapping the string around a groove or recess 54/58 in keel 18. Once the string 24 is fully wrapped around the keel 18, the weight 26 is placed over the keel 18. This is done by aligning the tips 74 on either side of the first recess or groove 54 in keel 18. Next, when in this position, the weight 26 is forced over the keel 18. As the weight 18 is forced over the keel 18, the angled sections 77 guide the fingers 62 around the recess or groove 54. Once the tangent points 78 pass the widest part of the keel 18 the weight 26 snaps in place or is frictionally held in place with the keel 18 held within opening 65 and the interior surface 72 engaging the inward facing surfaces of flanges 56 of recess or groove 54 in frictional engagement and/or the interior surface 72 engaging the outward facing surfaces of first recess or groove 54. Once weight 26 is attached, string 24 can be further tightened by rotating or twisting the weight 26 around keel 18 in the direction string 24 is wrapped to take up the remaining slack in string 24. This eliminates most or all of the loose string 24, thereby preventing or eliminating tangles. A benefit of this arrangement is that the weight 26 holds the string 24 in place in a storage position and the string 24 cannot become unintentionally detached or removed. This prevents tangles and provides a convenient package.

In one arrangement, the string 24 is wound around the neck section 58 by first attaching the weight 26 to the first recess 54 and then spinning the weight 26 around the keel 18 with care being taken to ensure that the string 24 wraps around the neck section 58 or alternatively around the first recess 54. The string 24 is fully wound when there is no more slack in string 24. The string 24 is then held in place by the friction between the weight 26 and the keel 18, thereby preventing fouling or knots.

In Operation:

When decoy 10 is floated upon the surface of a lake or pond, the generally round keep 18 allows the decoy 10 to quickly and easily rotate in even a light breeze because the keel 18 is non-directional. That is, when viewed from the bottom, keel 18 is generally round, and does not provide a preferred orientation or substantially resist rotation in a light breeze. This provides a more life-like decoy action.

Decoy 10 can be used for dry-land hunting by simply placing the decoy on the ground in the field. Due to the low-profile nature of the keel 18 and weight 26 and the extended flat bottom surface of keel 18 and weight 26 when attached thereto, the decoy 10 sits upright when placed on the ground. This provides a natural looking decoy. In addition, due to the weight being attached to the bottom of decoy 10, the decoy 10 has a tendency to remain upright even in high wind conditions. In addition, because the string 24 is wrapped around the keel 18, the string 24 does not have to be removed from around the neck or body of the decoy 10, which is often the case with conventional decoys.

Method of Manufacturing:

Conventional decoys are painted in a number of ways, including hand painting as well as complicated automated processes such as spray, air brushing, or the like. All of these prior art painting process suffer from deficiencies such as being time consuming, labor intensive, equipment intensive, requiring multiple steps (such as one step for each color), providing poor quality results, providing low resolution, providing an unnatural appearance, among many other disadvantages. One manner of painting decoy 10 is through a hydro-dipping process. Note, while the term “painting” is used herein, the term is to be construed broadly and is not limited to the conventional process using a paint brush to apply a single color at a time. Instead, the term painting as used herein is meant to include any process of applying color or pigmentation to a surface.

Hydro-dipping also known as hydrographics or HydroGraphics, immersion printing, water transfer printing, water transfer imaging or cubic printing, among other names, is a method of applying a printed designs to three-dimensional surfaces. The hydrographic process can be used on metal, plastic, glass, hard woods, and various other materials.

To hydro-dip decoy 10, the body 12 and/or head 14 is pre-treated and a base coat material is applied to the exterior surface of body 12 and/or head 14. This pre-treatment may include roughening the exterior surface of decoy 10 (head 14 and/or body 12) so as to facilitate greater adhesion, and/or applying an adhering agent to the exterior surface of decoy 10 (head 14 and/or body 12). Such as adhesive, and/or a cleaning agent to ensure that the surface of decoy 10 is clean and free of oils, dirt or other elements that may inhibit proper transfer of film 100 onto decoy 10 and to ensure complete adhesion between film 100 and decoy 10. A film 100 is printed that includes the desired appearance for body 12 and/or head 14. In one arrangement, film 100 includes a polyvinyl alcohol film with the graphic image to be transferred thereon. Next, the film 100 is floated on the surface of a tank 102 of water or other liquid 104.

Next, an activator chemical is sprayed on the film 100 to enable adhesion and transfer of the ink/graphics of the film 100 onto the decoy 10. In one arrangement, the activator chemical dissolves the film 100 into a liquid, gel or non-solid material that is conducive to transferring and adhesion. In this way, the film is activated as a bonding agent, or a bonding agent is applied to the film 100 and or the decoy 10. The body 12 and/or head 14 is then lowered into the tank 102 through the floating ink layer or activated/dissolved film 100. The ink layer or activated/dissolved film 100 along with the polyvinyl alcohol backing (which may be dissolved at this point) then wraps around and adheres to the surface of body 12 and/or head 14 as the water or liquid 104 surrounds decoy 10. The adhesion is a result of the chemical components of the activator softening the base coat layer and allowing the ink of film 100 to form a bond with the surface of decoy 10.

Once dipped, the body 12 and/or head 14 is removed from the tank 102. After removing the body 12 and/or head 14 from the water or liquid 102, the decoy 10 may be allowed time to dry, and/or the decoy 10 may be placed in an oven or other device to be blown or heated to accelerate the drying process and/or to activate or help harden the ink layer and/or film 100 on the decoy 10. In one arrangement, a top coat 106 is applied over the applied ink/film 100 once transferred to the decoy 10 to protect the design, increase durability and increase longevity of the feathered pattern transferred to the decoy 10. This top coat 106 may be placed on the decoy 10 by a spraying process, a dipping process or any other application process, either before or after the film 100 and ink layer dries or is baked on decoy 10 after the dipping process. In one arrangement, after the top coat 106 is placed over the ink layer/film 100 then the top coat 106 is itself allowed to dry or is cured by a heating, blowing or baking process. Please note that the term “baking” herein is intended to be broadly construed and includes any process that helps to cure or dry a layer of material applied to the surface of the decoy 10, including heating, exposing the decoy 10 to infrared energy, or any other like process.

The hydro-dipping process allows multiple colors and intense details to be printed on a 2-dimensional flat film with substantially high resolution and quality in a fast and efficient manner. Then, these multiple colors are quickly and easily applied to the 3-dimensional body 12 and/or head 14 in a single step in a fast, efficient and accurate manner. This process allows full 360° and three-dimensional coverage of the exterior surface of body 12 and/or head 14, including small crevices. Compared with airbrushing or painting, for example, the hydro-dipping process is much quicker and allows far higher resolution, more complex and detailed designs, greater consistency from decoy-to-decoy, and can be applied in a repeatable and reproducible manner. In addition, when compared with air brushing or painting, the hydro-dipping process allows for the simultaneous application and transfer of a plurality of colors that are aligned with one another (such as in a graphic). In addition, when compared with air brushing or painting, the hydro-dipping process allows for the simultaneous application of an image or graphic.

Most hydro-dipping processes are used to apply a non-oriented pattern on an object, such as applying a camouflage pattern to a gun or other object, as one example. In this conventional arrangement, the orientation of the pattern or design or film 100 with respect to the object does not matter, or precise alignment is not required as it is not achievable. That is, the purpose of adding camouflage to a gun is to break up its appearance and, generally speaking, a camouflage pattern would work equally as well whether it was put on in an aligned fashion, an unaligned fashion, inside out, upside down or whatever. As such, in most applications, where hydro-dipping is used, alignment does not matter. Hydro-dipping is used in these non-orientation applications because conventionally it has not been possible to align a hydro-dipped image to an object with any precision and/or repeatability due to great number of variables.

However, such is not the case in this application. That is, the feather pattern film 100 is to be aligned in the proper front-to-back alignment and the proper side-to-side alignment. In one arrangement, to assist with precise alignment of the decoy body 12 with the feather pattern on the film 100, one or more film alignment features 110 are intentionally placed on the film 100 to assist and aid alignment of the decoy 12 with the feather pattern of the film 100 during the hydro-dipping process. In one arrangement, the alignment features 110 include a mark or centerline positioned at one or both of the front-center of the film 100 and/or the rear-center of the film 100, in one arrangement outside of the usable area of the film, such as far ahead or far behind the usable section of the feather pattern, such that the film alignment features 110 are not readily visible on the exterior upper side of the decoy 10. In an alternative arrangement, the film alignment features 110 extend a portion of the usable portion of the film 100, or in yet another alternative arrangement, the film alignment features 110 extend most or all of the usable portion of the film 100. Location of the film alignment features 110 allows for quick and easy alignment of the feather pattern film 100 with respect to the decoy 10.

Similarly, in one arrangement, to assist with precise alignment of the decoy body 12 with the feather pattern on the film 100, one or more body alignment features 112 are intentionally placed on the film 100 to assist and aid alignment of the decoy 12 with the feather pattern of the film 100 during the hydro-dipping process. In one arrangement, the alignment features 110 include a mark or centerline positioned at one or both of the front-center of the film 100 and/or the rear-center of the bottom side 34 of the decoy body 12, where it is not readily visible during conventional use. Alternatively, the decoy body alignment features 112 include the front string attachment member 20 and/or the rear string attachment member 22 and/or a seam line 114 that is formed at the connection point of two opposing mold-halves (such as blow molding mold halves).

In an alternative arrangement, no additional alignment features are placed on the film 100 or incorporated into the film. Instead, the natural features of the graphic on film 100 are used for alignment, such as the natural center-line of the feather pattern used as an example herein. Alternatively, the dimensions, center, edges or other known features of the film 100 itself are used for alignment. Then a process is developed to repeatably align the decoy 10 to the body 12 with respect to these inherent features of the film 100 to precisely and repeatably dip decoy 10 and apply film 100. In one arrangement, motorization, alignment jigs and/or robotics are used and programmed to precisely align the body with film 100 to apply the film to decoy 10.

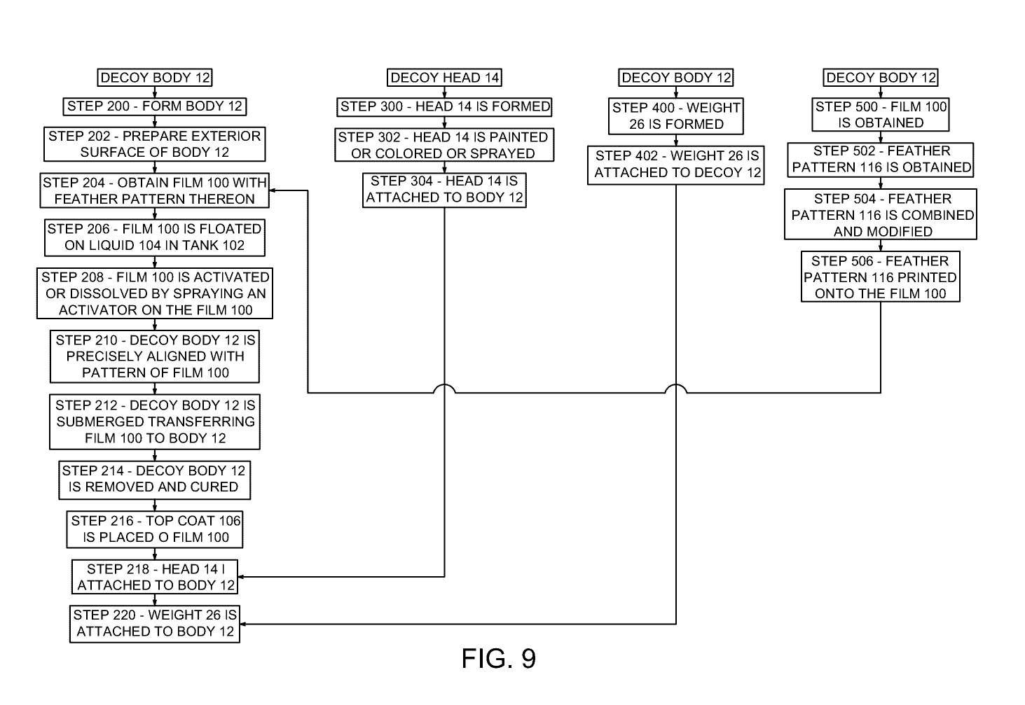

With reference to FIG. 9, in one arrangement system 10 is formed as follows:

At step 200, a decoy body is formed by way of a manufacturing process such as blow molding, injection molding, roto molding or the like process. Care is taken to ensure that the edges of the decoy are sufficiently smooth and rounded such that during the hydro-dipping process the film 100 is properly adhered to the exterior surface of the decoy body 12. If the features or shape of the body 12 are too sharp or too drastic, the film 100 will not properly conform to the shape of the body 12 and will not properly cover the body 12. In one arrangement, the molding process includes simultaneously forming the body alignment features 112 therein; in another arrangement, the body alignment features 112 are formed in the body 12 in a secondary operation, such as marking, scratching, drawing, painting, writing, or the like onto the body 12.

At step 202, the exterior surface of the decoy body 12 is prepared for reception of film 100. This may include cleaning and/or roughening the exterior surface of the decoy body 12 or spraying an adhesive-promoting layer on the exterior surface of the decoy body 12 or any combination thereof or other process.

At step 204, the film 100 having a feather pattern, or any other pattern or graphics, thereon is obtained. The ink or coloring may be placed on the film by printing, transferring, vacuum deposition, rolling, or any other process. In one arrangement, the film 100 may be formed with film alignment features 110 thereon, or they may be added by a secondary operation, such as marking or printing or the like.

At step 206, the film 100 is floated on liquid 104 in transfer tank 102.

At step 208, once floated, the film 100 having the desired pattern thereon is sprayed with an activator that dissolves or activates the film, leaving the ink or pattern or graphics in a condition to be transferred to the decoy body 12.

At step 210, the decoy body 12 is precisely aligned with the pattern of the film 100. That is, the decoy body 12 is aligned front-to-back, and side-to-side with the front, back and sides of the film 100. This alignment, and the following step of dipping, may be accomplished with the use of alignment jigs, motorization and/or robotics to provide a repeatable process and eliminate as many variables as possible.

At step 212, once aligned, the decoy body 12 is carefully submerged into the tank 102 of water or liquid 104 through the film 100 with care being taken to ensure that the pattern/ink of film 100 is aligned and transferred in a cohesive manner to the body 12.

At step 214, once the film 100 is transferred to the decoy body 12, the decoy body 12 is removed from the water or liquid 104 and is allowed to dry (either by air drying or by blowing on the decoy body 12), is baked (broad definition) or is allowed to stand for a period of time.

At step 216, before, during or after film 100 dries on decoy body 12, a top coat 106, such as a clear layer of a durable coating is applied to the exterior surface of the now-transferred pattern of film 100, thereby providing added protection and durability to the pattern of film 100. In one arrangement, top coat 106 is allowed to dry (either by air drying or by blowing on the decoy body 12), is baked (broad definition) or is allowed to stand for a period of time after being applied.

At step 218, the head 14 is frictionally forced into the opening 43 in the body 12 of decoy 10 tightly holding the head 14 to the body 12 while simultaneously allowing for rotation of head 14 with respect to body 12 and removal of head 12 with respect to body 14.

In one arrangement, the body 12 and/or the head 14, and/or the pattern on the film 100 are symmetrically formed so as to facilitate alignment and transition of the film 100 onto the body 12 and/or head 14.

At step 300, the head is formed by way of a manufacturing process such as blow molding, injection molding, roto molding or the like process, much like the manner in which the body 12 is formed. In one arrangement, the molding process includes simultaneously forming the alignment features therein; in another arrangement, alignment features are absent or are formed in the head 14 in a secondary operation, such as marking, scratching, drawing, painting, writing, or the like.

At step 302, the exterior surface of the head 14 is conventionally painted, or spray painted, or alternatively, the head goes through the same or similar process described with respect to body 12 (e.g. step 202 through step 216).

At step 304, head 14 is added to the opening 43 in body 12.

At step 400, weight 26 is formed, by any manner or method such as blow molding, injection molding, roto molding or the like process. In one arrangement, weight 26 is injection molded out of a mixture of plastic or composite and denser metallic material.

At step 402, once formed, weight 26 is attached to decoy body 12 by string 24 which is connected to keel 18, front or rear string attachment member 20, 22 or any other portion of the decoy 12.

At step 500, a film 100 is obtained. The film 100 being a generally flexible, generally transparent, semi-transparent, clear or semi-clear thin film that is configured to be floated upon water 104 in tank 102 during a hydro-dipping process.

At step 502 a feather pattern 116 or other pattern is obtained. In the arrangement, wherein a duck is to be mimicked, pictures are taken of the upper side, front side, back side, left side and right side of the duck.

At step 504, the images are then combined to form a continuous image of the outside appearance of a duck or other animal to be mimicked. These images are then modified, distorted or configured to conform to the varying three dimensional shape of the decoy body 12 during the transfer process. These images are further modified to account for the distortion that occurs as a result of the hydrodynamics of the hydro-dipping process.

At step 506 the feather pattern 116 is transferred onto the film 100 through a printing process or any other transfer process.

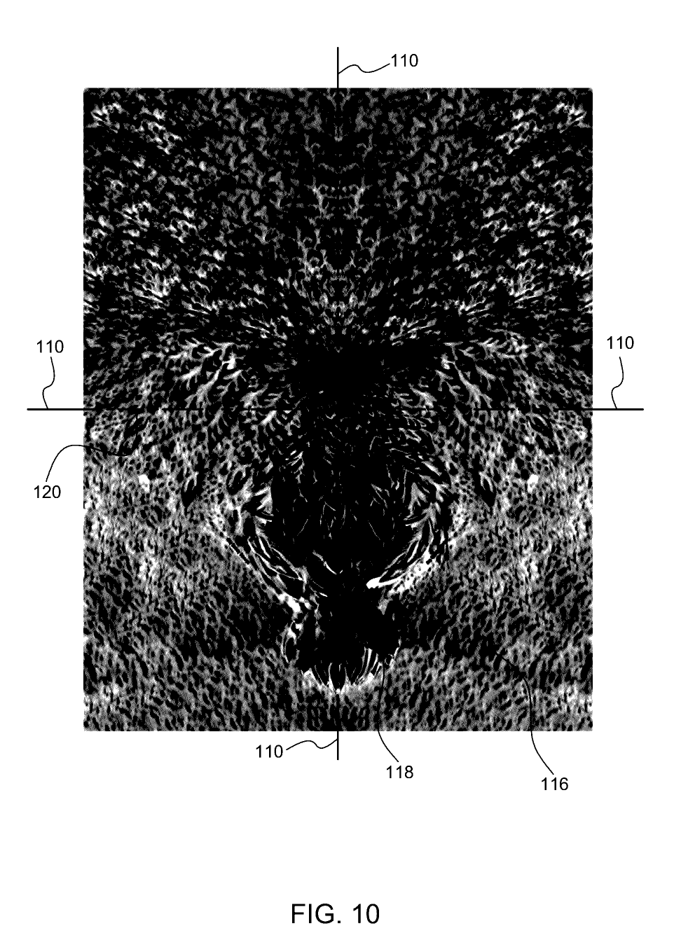

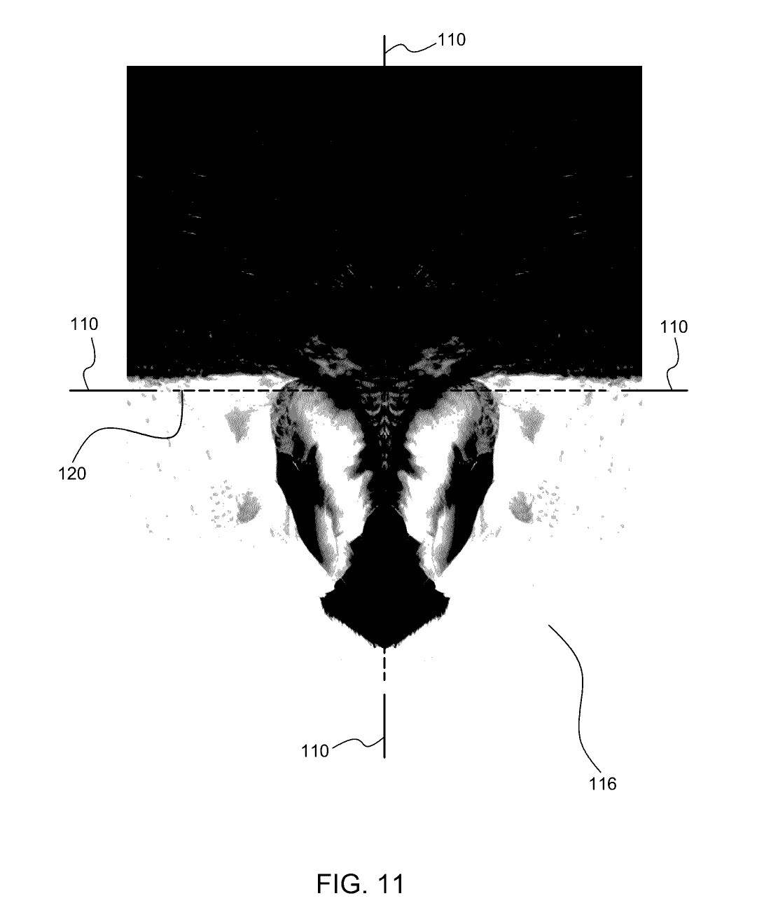

With Reference to FIG. 10 and FIG. 11, examples of film 100 are presented. In one arrangement, film 100 is a generally flexible, generally transparent, semi-transparent, clear or semi-clear thin film. In one arrangement, film 100 is configured to float upon water 104 or other liquid in tank 102 during a hydro-dipping process; and film 100 is configured to be dissolved or activated by spraying an activator on film 100 thereby preparing film 100 to transfer the graphics it carries onto another object during a hydro-dipping process.

In the arrangement shown, as examples, FIG. 10 and FIG. 11 show a feather pattern 116 placed upon film 100, however any other form of graphics are hereby contemplated for use, such as a fur pattern. In one arrangement, feather pattern 116 formed by printing a feather pattern 116 onto film 100. Printing feather pattern 116 onto film 100 provides the benefit of printing feather pattern 116 onto a flat film 100 which is then transferred onto the three dimensional decoy 10. This allows the utilization of high quality or high definition printers that are generally available and are cost effective and have a high throughput. This allows for fast, high quality, low cost printing of feather pattern 116 onto a two dimensional film 100 which is then transferred onto the three dimensional decoy 10. The term printing herein is to be broadly construed to cover any method of transferring feather pattern 116 onto film 100.

The feather pattern 116 is created by taking images of actual feather patterns of waterfowl, such as ducks, geese or the like or any other animal or object that is to be mimicked. As an example, top, front, left side, right side, and back side images are taken. These images are then combined together or digitally stitched together, to form a single image. This image is then modified, adjusted or distorted to conform the flat or two dimensional image to account for the transfer process onto the three dimensional decoy 10. That is, sections of the image may be condensed, or stretched, or modified in any other way to account for the way the film 100 will wrap around the decoy 10 during the transfer process. The resulting feather pattern 116 is a modified and distorted image of feathers that has a front side, a back side, a left side, a right side and an upper side that when transferred onto the decoy 10 body 12 provides a lifelike appearance of an actual duck, goose or other waterfowl that is being imitated.

Naturally, as most waterfowl tend to have a symmetric appearance, there tends to be a front to back centerline 118 that extends through the center of the feather pattern 116. As stated herein, aligning the feather pattern 116/film 100 with the body 12 is important to provide an optimal appearance. In one arrangement, the film 100/feather pattern 116 is applied by aligning this natural front to back centerline 118 with the seam line 114 in the bottom of body 12. To improve alignment of the feather pattern 116/film 100 with the body 12, film alignment features 110 are added to the front and/or the back and/or the sides of the film 100/feather pattern 116. These film alignment features 110 may be formed of any suitable size, shape or design. In one arrangement, as is shown, simple lines may be used at the edges or just outside of the feather pattern 116. These film alignment features 110 are configured to be aligned with similar body alignment features 112 in body 12. In one arrangement the center or edges or corners or any other known position, size or shape of the film 100 is used as a film alignment feature 110. Once the film alignment features 110 are aligned with the corresponding body alignment features 112, the body 12 is submerged through the film 100 in a proper alignment.

The side film alignment features 110 are aligned with a side to side centerline 120. This side to side centerline 120 helps to ensure that the body 12 is properly aligned front to back on film 100/feather pattern 116. That is, while it may be somewhat self-explanatory or easier to align the front to back centerline 118 of the body 12 with the film 100 because both have a natural centerline due to the side-to-side symmetry of the decoy body 12 and feather pattern 116, no such symmetry exists to assist with front to back alignment of the body 12 to the film 100/feather pattern 116. As such, placing side film alignment features 110 on film 100, and corresponding side body alignment features 112 on body 12 aid in this front to back alignment.

In one arrangement, jigs, motorization and/or robotics are used to accurately and repeatably position the decoy 10 with respect to the film 100, as well as to perform the dipping process.

As is shown in FIG. 10 a hen or female duck pattern is provided. As is shown in FIG. 11 a drake or male duck pattern is provided. Any number of other feather patterns 116 are hereby contemplated for use and can be formed and applied using the techniques described herein.

Printing feather pattern 116 on film 100 also allows the application of a name or trademark onto the feather pattern in a conspicuous or inconspicuous place to provide convenient branding opportunities. As one example, as can be seen, in FIGS. 10 and 11, the Applicant's trademark “Big Daddy Decoys” is positioned in the feather pattern adjacent each side near the mid-rear of the feather pattern.

Accordingly, from the above discussion it will be appreciated that the improved decoy system and a method of manufacturing and use thereof that improves upon the present state of the art; is high quality; is easy to use; is durable; is inexpensive; can be used in water or on land; is convenient to use; eliminates or reduces tangles; sits upright in water or on land; provides a convenient place for storing the string; holds the string in place; has an intuitive design; reduces the cost of painting; speeds the painting process; eliminates the need for conventional painting; has a high quality intricate ornamental appearance; can be deployed more-quickly in the field; can be retrieved and stored more-quickly in the field, among countless other improvements and advantages.

It will be appreciated by those skilled in the art that other various modifications could be made to the device without parting from the spirit and scope of this invention. All such modifications and changes fall within the scope of the claims and are intended to be covered thereby.

What is claimed:

1. A decoy system comprising:
a body;
the body having a front side, a rear side, a left side, a right side, an upper side and an underside;
a head connected to the upper side of the body;
a keel connected to the underside of the body; and
a weight connected to the keel such that the weight is held in place when connected to the keel.

2. The decoy system of claim 1 wherein the weight fits around the keel and is frictionally held in place around the keel.

3. The decoy system of claim 1 further comprising a string attachment member connected to the underside of the body, a string connected on a first end to the string attachment member, the string connected on a second end, opposite the first end, to the weight.

4. The decoy system of claim 1 further comprising a string connected to the body and the weight wherein when in a storage position the string is wrapped around the keel and the weight is placed over the keel.

5. The decoy system of claim 1 wherein when the weight is connected to the keel, the decoy sits in an upright positioned when placed on a generally flat surface.

6. The decoy system of claim 1 wherein the decoy converts between a storage position, wherein the string is wrapped around the keel and the weight is placed over the keel; and a deployed position wherein the weight is removed from the keel and the string is unwrapped from around the keel.

7. The decoy system of claim 1 wherein when viewed from below, the keel is generally circular in shape when viewed from below.

8. The decoy system of claim 1 wherein when viewed from the side, the keel has a first recess therein that receives the string when the string is wrapped around the keel.

9. The decoy system of claim 1 wherein when viewed from the side, the keel has a second recess therein that receives the weight when the weight is connected to the keel.

10. The decoy system of claim 1 wherein the weight includes a pair of fingers that form an opening, wherein the keel is received within the opening between the fingers of the weight in a storage position.

11. A method of manufacturing a decoy, the method comprising the steps of:
providing a decoy body;
providing a film having a desired ornamental appearance; and
applying the film to the body by a hydro dipping process.

12. The method of claim 11 wherein the decoy body is formed by the process selected from the group consisting of: blow molding, injection molding and roto molding.

13. The method of claim 11 further comprising the step of applying a head to the body.

14. A method manufacturing a decoy, the steps comprising:
forming a decoy body having a front end, a rear end, a left side, a right side, an upper side and an underside;
creating a feather pattern on a film having a front end, and a rear end, a left side and a right side;
placing the feather pattern film on a liquid such that the feather pattern film floats on the liquid;
dissolving the film leaving the feather pattern floating on the liquid;
aligning the front end of the decoy body with the front end of the feather pattern, aligning the rear end of the decoy body with the rear end of the feather pattern, aligning the right side of the decoy body with the right side of the feather pattern, aligning the left side of the decoy body with the right side of the feather pattern;
submerging the decoy body in the liquid once the decoy body is aligned with the feather pattern, thereby adhering the feather pattern onto the decoy body;
removing the decoy body from the liquid with the feather pattern affixed to the decoy body.

15. The method of claim 14, further comprising the step of spraying a clear coat over the feather pattern after the feather pattern is affixed to the decoy body.

16. The method of claim 14, further comprising the step of providing alignment features on the film, wherein the alignment features assist with aligning the decoy body with the film.

17. The method of claim 14 further comprising the steps of:
forming a head;
painting the head;
attaching the head to the decoy body such that the head is rotatable with respect to the decoy body.

18. A film for covering a decoy comprising:
a flexible film;
a feather pattern placed on the film;
the feather pattern having a front side, a back side, a left side and a right side;
the film configured to be transferred onto a decoy, thereby providing a life-like appearance of the decoy.

19. The film of claim 18, wherein the feather pattern is that of a hen (a female duck) or a drake (a male duck).

20. The film of claim 18, wherein the feather pattern is printed onto the film by a printing process.
